(19) United States
(12) Patent Application Publication
(10) Pub. No.: US 2012/0296652 A1
(43) Pub. Date: Nov. 22, 2012

(54) OBTAINING INFORMATION ON AUDIO VIDEO PROGRAM USING VOICE RECOGNITION OF SOUNDTRACK

(75) Inventors: Seth Hill, La Mesa, CA (US); Frederick J. Zustak, Poway, CA (US)

(73) Assignee: SONY CORPORATION

(21) Appl. No.: 13/110,220

(22) Filed: May 18, 2011

(51) Int. Cl. G10L 11/00; G10L 15/04

(52) U.S. Cl. 704/251; 704/270; 704/E15.001; 704/E11.001

(57) ABSTRACT

A method for obtaining information on an audio video program being presented on a consumer electronics (CE) device includes receiving at the CE device a viewer command to recognize the audio video program being presented on the CE device. The method also includes receiving signals from a microphone representative of audio from the audio video program as sensed by the microphone as the audio is played real time on the CE device. The method then includes executing voice recognition on the signals from the microphone to determine words in the audio from the audio video program as sensed by the microphone. Words are then uploaded to an Internet server, where they are correlated to at least one audio video script. The method then includes receiving back from the Internet server information correlated by the server using the words to the audio video program.

### I. FIELD OF THE INVENTION

The present application relates generally to obtaining information on audio video programs presents on consumer electronics (CE) devices such as TVs using voice recognition of the soundtrack.

### II. BACKGROUND OF THE INVENTION

Technology increasingly provides options for users to view audio video programs and/or content. These programs may be viewed on, e.g., a high-definition television, a smart phone, and a personal computer. These audio video programs may also be derived different sources, e.g., the internet or a satellite television provider.

Often, users desire information pertaining to the program being viewed, where that information may not necessarily be easily discernable or accessible to them. For example, a user may desire information regarding the names of individuals acting in a program. The present application recognizes the difficulty of acquiring information pertaining to an audio video program.

### SUMMARY OF THE INVENTION

Thus, present principles recognize that it is advantageous to provide a relatively simplistic way for a user to ascertain information pertaining to an audio video program. Accordingly, a method for obtaining information on an audio video program being presented on a consumer electronics (CE) device includes receiving at the CE device a viewer command to recognize the audio video program being presented on the CE device.

The method may also include receiving signals from a microphone, where the signals may be representative of audio from the audio video program being presented on the CE device as sensed by the microphone as the audio is played real time on the CE device. If non-limiting implementations, the method may also include executing voice recognition on the signals from the microphone to determine words in the audio from the audio video program being presented on the CF device as sensed by the microphone. Additionally, the method may also include uploading the words to an Internet server and receiving back from the Internet server information correlated by the server using the words to the audio video program being presented on the CE device. Even further, in some non-limiting implementations, the method may also include capturing from the signals from the microphone a predetermined number of words in the audio from the audio video program as sensed by the microphone, and uploading the predetermined number of words and no others to the Internet server.

If desired, the method may also include that the information correlated by the server using the words to the audio video program being presented on the CE device may include artistic contributors to the audio video program. Further, in non-limiting implementations, the information received from the server may include links to Internet sites selectable by the viewer to access the Internet sites to download information pertaining to the audio video program.

In some implementations, the CE device may receive from the server recommendations for additional audio video programs responsive to uploading the words to the server. Additionally, in non-limiting implementations, the method may also include receiving from the server advertisements responsive to uploading the words to the server.

In non-limiting embodiments, the CE device may be a TV, and the viewer command to recognize the audio video program being presented on the CE device may be received from selection of a “recognize” selector on a TV options user interface. In other non-limiting embodiments, the CE device may be a personal computer (PC), and the viewer command to recognize the audio video program being presented on the CE device may be received from selection of a right click-instantiated selectable “recognize” selector. In still other non-limiting embodiments, the CE device may be a smart phone, and the viewer command to recognize the audio video program being presented on the CE device may be received from selection of a “recognize” selector on a phone options user interface menu.

In another aspect, a server may include a processor and a database of audio video program scripts. The processor may receive words over the Internet from a consumer electronics (CE) device, where the words may be recognized by the CE device from a soundtrack of an audio video program being presented on the CE device. In non-limiting implementations, the processor may access the database and use the words to match the words to at least one audio video program script. If desired, the server may also return to the CE device information related to an audio video program whose soundtrack is an audio video script matching the words.

In still another aspect, a system may include a consumer electronics (CE) device and a server. The server may include a processor and a database, where the database may have audio video program soundtracks. In non-limiting embodiments, the processor may receive audio signal(s) over the Internet from an audio video program being presented on the CE device. The processor may use the audio signal(s) to access the database to match the audio signal(s) to at least one audio video program. If desired, the processor may return information to the CE device related to an audio video program whose soundtrack matches the audio signal(s).

The details of the present application both as to its structure and operation may be seen in reference to the accompanying figures, in which like numerals refer to like parts, and in which:

### BRIEF DESCRIPTION OF THE DRAWINGS

FIG. 1 is a block diagram of a non-limiting example system in accordance with present principles;

FIG. 2 is a flow chart of example logic for acquiring information related to an audio video program in accordance with present principles;

FIG. 3 is a flow chart of example logic for determining audio video programs the server may recommend in accordance with present principles;

FIG. 4 is a flow chart of example logic for determining advertisements the server may send to a CE device in accordance with present principles; and

FIGS. 5 and 6 are example screen shots including information related to an audio video program that may be presented on a CE device.

### DETAILED DESCRIPTION OF A PREFERRED EMBODIMENT

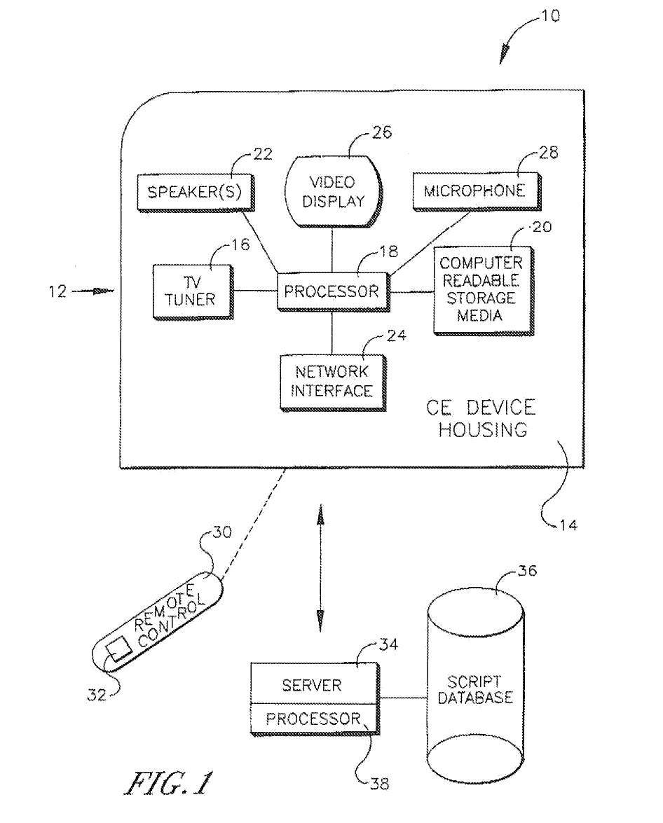

Referring initially to the non-limiting example embodiment show in FIG. 1, a system 10 includes a consumer electronics (CE) device 12 such as a TV including a housing 14 and a TV tuner 16 communicating with a TV processor 18 accessing a tangible computer readable storage medium or media 20 such as disk-based or solid state storage. The CE device 12 can output audio on one or more speakers 22 and can receive streaming video from the Internet using a network interface 24 such as a wired or wireless modem communicating with the processor 18 which may execute a software-implemented browser. Video is presented under control of the TV processor 18 on a TV display 26 such as but not limited to a high definition TV (HDTV) flat panel display. A microphone 28 may be provided on the housing 14 in communication with the processor 18 as shown. Also, user commands to the processor 18 may be wirelessly received from a remote control (RC) 30 using, e.g., rf or infrared. In the example shown the RC 30 includes an information key 32. Audio video display devices other than a TV may be used.

Using the network interface 24, the processor 18 may communicate with an information server 34 having a processor 38 to access a script database 36 for purposes to be shortly disclosed.

TV programming from one or more terrestrial TV broadcast sources as received by a terrestrial broadcast antenna which communicates with the TV 12 may be presented on the display 26 and speakers 22. TV programming from a cable TV head end may also be received at the TV for presentation of TV signals on the display 26 and speakers 22. Similarly, HDMI baseband signals transmitted from a satellite source of TV broadcast signals received by an integrated receiver/decoder (IRD) associated with a home satellite dish may be input to the TV 12 for presentation on the display 26 and speakers 22. Also, streaming video may be received from one or more content servers via the Internet and the network interface 24 for presentation on the display 26 and speakers 22.

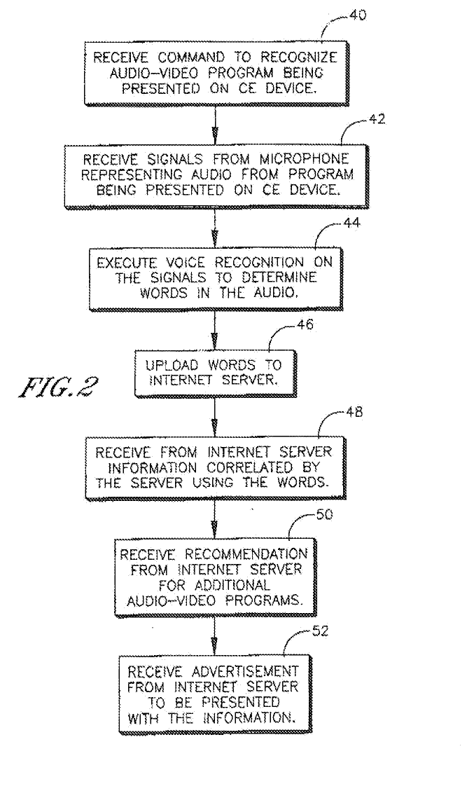

Now referring to FIG. 2, a flow chart of example logic in accordance with present principles is shown. Beginning with block 40, the logic may receive a request for information pertaining to an audio video program being presented on a CE device, such as the CE device 12 described above. Thus, the CE device may be a TV, where the request for information pertaining to the audio video program may be received from selection of a “recognize” selector on an options user interface similar to, e.g., the information key 32 of FIG. 1. However, the CE device may also be a personal computer (PC) in non-limiting embodiments, where the viewer command to recognize the audio video program may be received from selection of a right click-instantiated selectable “recognize” selector. In still other non-limiting embodiments, the CE device may be a smart phone, where the viewer command to recognize the audio video program may be received from selection of a “recognize” selector on a phone options user interface menu.

Regardless, at block 42 of FIG. 2, the logic may receive signals from a microphone on the CE device, such as the microphone 28 described above in non-limiting embodiments, representative of audio from the audio video program being presented on the CE device as sensed by the microphone as the audio is played real time on the CE device. It is to be understood that, in non-limiting embodiments, a predetermined number of words (e.g., ten) in the audio, and/or a portion and/or segment of the audio having a predetermined temporal length of the audio may be captured from the signals by the microphone.

Then, at block 44 of FIG. 2, the logic may execute voice recognition on the signals from the microphone to determine words in the audio from the audio video program being presented on the CE device as sensed by the microphone. Moving to block 46, the logic may then upload the words to an Internet server, such as the server 34 described above in non-limiting embodiments. It is to be understood that, in some implementations, the information may be uploaded over the internet. In non-limiting embodiments, it is to be further understood that only the predetermined number of words disclosed above, and no others, may be uploaded to the Internet server. Further still, in non-limiting embodiments, only the portion and/or segment of the audio having a predetermined temporal length, and no other portion and/or segment of the audio, may be uploaded to the Internet server.

Still in reference to FIG. 2, the logic may then conclude at block 48, where the logic may receive back from the Internet server information correlated and/or matched by the server using the words to the audio video program being presented on the CE device. In non-limiting embodiments, the information may include artistic contributors to the audio video program, production data such as which studio owns the legal rights to the program, where the program was filmed and/or produced, data pertaining to the popularity of the program (generated by, e.g., a technique knows as “data mining”), and/or still other data pertaining to the program. Further, the information may also include links to Internet sites selectable by the viewer to access the Internet sites to download information pertaining to the audio video program and/or to purchase additional audio video content or programs that may be associated with the audio video program in non-limiting embodiments.

It is to be understood that the server may have a processor and a database of audio video program scripts, such as the processor 38 and database 36 described above, in non-limiting embodiments. Thus, a processor on a CE device may communicate with the server to access a script database, where the processor on the server may receive the words uploaded from the CE device over the Internet and recognized by the CE device from a soundtrack of an audio video program being presented on the CE device.

The server may then use the words when accessing the database to correlate and/or match the words to at least one script. The server may then return information related to an audio video program whose soundtrack is a script matching the words to the CE device, which is received at block 48 as described above. It is to be understood that the script or scripts in the database may be audio scripts. It is to be further understood that the scripts in the database may be derived from closed caption text associated with the audio video program.

Still in reference to FIG. 2, alternative to concluding at block 48, in non-limiting embodiments the logic may proceed to block 50. At block 50, the logic may receive from the server recommendations for additional audio video programs responsive to uploading the words to the server and/or associated with an attribute of the script(s) correlated to the words. If the desired, the logic may then proceed to block 52, where the logic may receive from the server advertisements responsive to uploading the words to the server and/or associated with an attribute of the script(s) correlated to the words.

Turning to FIG. 3, a flow chart of example logic for determining audio video programs the server may recommend in accordance with present principles is shown. Thus, beginning at block 54, the logic may correlate and/or match words uploaded to the server from a CE device presenting an audio video program with at least one audio video script. Then at block 56, the logic may associate the script(s) matched to the words at block 54 with other audio video programs sharing artistic attributes. Such attributes may include, e.g., audio video genres, artistic contributors such as actors, and production studios. Concluding at block 58, recommendations containing other audio video programs sharing artistic attributes with the audio video program may be sent to the CE device to be presented to a user of the CE device.

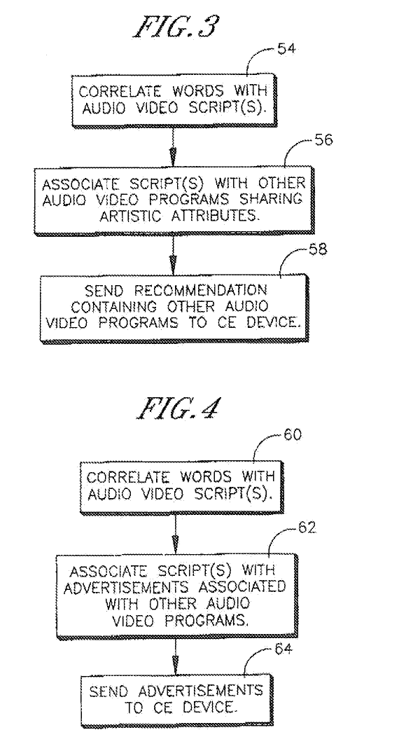

Now in reference to FIG. 4, a flow chart of example logic for determining advertisements the server may send to a CE device in accordance with present principles is shown. Beginning at block 60, the logic may correlate and/or match words uploaded to the server from a CE device presenting an audio video program with at least one audio video script. Then at block 62, the logic may associate the script(s) matched to the words with advertisements. The advertisements may be related to additional audio video programs sharing artistic attributes with the audio video program being presented on the CE device in non-limiting embodiments. Such attributes may include, e.g., audio video genres, artistic contributors such as actors, and production studios. However, it is to be understood that the advertisements may pertain to products and/or services that are unassociated with attributes of the audio video program being presented on the CE device. Regardless, the logic concludes at block 64, where the advertisements may be provided to the CE device to be presented to a user of the CE device.

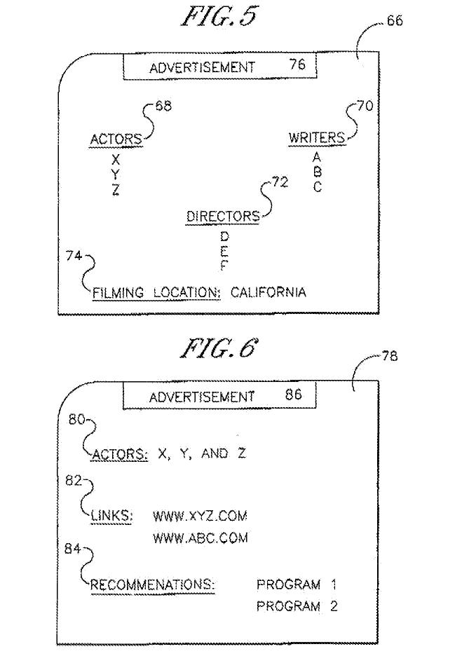

Moving on to FIG. 5, a non-limiting example screen shot of information that may be presented on a CE device in accordance with present principles is shown. The screen shot 66 may include a list of actors 68, a list of writers 70, and a list of directors 72 that contributed to an audio video program being presented on a CE device in accordance with present principles. It is to be understood that, as used herein, letters such as “X,” “A,” and “E,” are provided in the screen shots described herein for simplicity, but that, in non-limiting embodiments, the full names of, e.g., actors, writers and directors would be presented. The screen shot 66 of FIG. 5 may also include location information 74 pertaining to where the audio video program was filmed, such as, e.g., California. Even further, the screen shot 66 may include an advertisement 76 in accordance with present principles.

Concluding with FIG. 6, another non-limiting example screen shot of information that may be presented on a CE device in accordance with present principles is shown. The screen shot 78 may include a list of actors 80. The screen shot 78 may also provide links 82 to Internet sites selectable by the viewer to access the Internet sites containing information pertaining to the audio video program for which the information is being provided and/or to purchase related additional audio video content or programs in accordance with present principles. The screen shot 78 may also include recommendations 84 regarding additional audio video programs sharing artistic attributes with the audio video program for which the information is being provided, such as, e.g. “Program 1” and “Program 2” as shown in the non-limiting screen shot of FIG. 6. Additionally, in non-limiting embodiments, the screen shot 78 may include an advertisement 86 in accordance with present principles.

While the particular OBTAINING INFORMATION ON AUDIO VIDEO PROGRAM USING VOICE RECOGNITION OF SOUNDTRACK is herein shown and described in detail, it is to be understood that the subject matter which is encompassed by the present invention is limited only by the claims.

What is claimed is:

1. Method for obtaining information on an audio video program being presented on a consumer electronics (CE) device, comprising:
receiving at the CE device a viewer command to recognize the audio video program being presented on the CE device;
receiving signals from a microphone representative of audio from the audio video program being presented on the CE device as sensed by the microphone as the audio is played real time on the CE device;
executing voice recognition on the signals from the microphone to determine words in the audio from the audio video program being presented on the CE device as sensed by the microphone;
uploading the words to an Internet server; and
receiving back from the Internet server information correlated by the server using the words to the audio video program being presented on the CE device.

2. The method of claim 1, wherein the information correlated by the server using the words to the audio video program being presented on the CE device includes artistic contributors to the audio video program.

3. The method of claim 1, comprising capturing from the signals from the microphone a predetermined number of words in the audio from the audio video program being presented on the CE device as sensed by the microphone and uploading the predetermined number of words and no others to the Internet server.

4. The method of claim 1, wherein the information received from the server includes links to Internet sites selectable by the viewer to access the Internet sites to download information pertaining to the audio video program.

5. The method of claim 1, comprising receiving from the server recommendations for additional audio video programs responsive to uploading the words to the server.

6. The method of claim 1, comprising receiving from the server advertisements responsive to uploading the words to the server.

7. The method of claim 1, wherein the CE device is a TV and the viewer command to recognize the audio video program being presented on the CE device is received from selection of a “recognize” selector on a TV options user interface.

8. The method of claim 1, wherein the CE device is a personal computer (PC) and the viewer command to recognize the audio video program being presented on the CE device is received from selection of a right click-instantiated selectable “recognize” selector.

9. The method of claim 1, wherein the CE device is a smart phone and the viewer command to recognize the audio video program being presented on the CE device is received from selection of a “recognize” selector on a phone options user interface menu.

10. A server, comprising:
a processor;
a database of audio video program scripts, the processor:
receiving words over the Internet from a consumer electronics (CE) device, the words being recognized by the CE device from a soundtrack of an audio video program being presented on the CE device;
using the words, accessing the database to match the words to at least one audio video program script; and
returning to the CE device information related to an audio video program whose soundtrack is an audio video script matching the words.

11. The server of claim 10, wherein the scripts in the database are audio scripts.

12. The server of claim 10, wherein the scripts in the database are derived from closed caption text associated with the audio video program.

13. The server of claim 10, wherein the number of words used to match the words to at least one audio video program script is predetermined.

14. The server of claim 10, wherein the information returned by the server includes links to Internet sites selectable by the viewer to access the Internet sites to download information pertaining to the audio video program.

15. The server of claim 10, wherein the information returned by the server includes recommendations for additional audio video programs responsive to the words received by the server.

16. The server of claim 10, wherein the server returns advertisements responsive to the words received by the server.

17. A system, comprising:
a consumer electronics (CE) device;
a server having a processor;
a database of audio video program soundtracks on the server; wherein the processor:
receives audio signal(s) over the Internet from an audio video program being presented on the CE device;
uses the audio signal(s) to access the database to match the audio signal(s) to at least one audio video program; and
returns information to the CE device related to an audio video program whose soundtrack matches the audio signal(s).

18. The system of claim 17, wherein a portion and/or segment of the audio signal(s) having a temporal length being used to match the audio signals to at least one audio video program is predetermined.

19. The system of claim 17, wherein the information returned by the server includes links to Internet sites selectable by the viewer to access the Internet sites to download information pertaining to the audio video program.

20. The system of claim 17, wherein the information returned by the server includes recommendations for additional audio video programs responsive to the audio signals received by the server.
